(19) United States
(12) Patent Application Publication
(10) Pub. No.: US 2011/0010095 A1
(43) Pub. Date: Jan. 13, 2011

(54) POTENTIAL FIELD DATA SURVEY

(75) Inventors: NEIL DYER, Cambridge (GB); Phillip Houghton, Cambridge (GB); Gary Barnes, Cambridge (GB)

Correspondence Address: FOLEY AND LARDNER LLP;SUITE 500, 3000 K STREET NW, WASHINGTON, DC, 20007, US

(73) Assignee: ARKeX Limited

(21) Appl. No.: 12/831,124

(22) Filed: Jul. 6, 2010

(30) Foreign Application Priority Data
Jul. 7, 2009 (GB) 0911776.3

(51) Int. Cl. G06F 19/00; G01V 3/38

(52) U.S. Cl. 702/5

(57) ABSTRACT

Conducting a potential field survey of a survey surface includes a method, a system, and/or a non-transitory computer-readable storage medium. In some embodiments of these techniques, the method includes determining a set of paths along an observation surface at an observation height above the surface survey, and measuring potential field data at points on said paths, wherein said set of paths comprises at least one reference path and a plurality of survey paths associated with said at least one reference path wherein the distance between each of the plurality of survey paths and the reference path is a function of the observation height. Said set of paths may define a generally fan-shaped pattern diverging from a common region. This Abstract is provided for the sole purpose of complying with the Abstract requirement rules. This Abstract is submitted with the explicit understanding that it will not be used to interpret or to limit the scope or the meaning of the claims.

### CROSS-REFERENCE TO RELATED APPLICATIONS

This application claims priority to United Kingdom Patent Application No. 0911776.3, filed Jul. 7, 2009, which is incorporated herein by reference in its entirety.

### FIELD OF THE INVENTION

This invention relates to improved techniques for acquiring potential field measurement data from surveys such as gravity surveys, gravity gradiometry surveys, etc. Such surveys may be airborne surveys or marine surveys (i.e., bathymetric surveys).

### BACKGROUND

Conventionally potential field surveys such as gravity surveys are conducted along a grid pattern. The grid is defined by orthogonal sets of parallel lines on a two-dimensional surface. For airborne surveys, the parallel lines define flight paths which satisfy a minimum height constraint (defined by the closest the aircraft is permitted to fly to the ground) and a constraint on the maximum rate of climb/descent of the aircraft, typically around three percent. For marine surveys, the parallel lines define paths to be followed by a vessel.

This approach suffices for airborne flat terrain but for hilly or mountainous terrain the surface on which the aircraft flies can vary by as much as two or three kilometres from, say, the bottom of an underlying valley to the top of the mountains/survey area. Similarly, for marine surveys over areas of steep bathymetric change such as the shelf margins shown in FIGS. 1 and 2, the effects of the rapidly changing bathymetry can lead to considerable signal aliasing (i.e. the signals from different depths because indistinguishable when acquired). Accordingly, another approach to collecting potential field data is needed.

In WO 2007/012895 to the present applicant (herein incorporated by reference), a survey pattern which obtained the measured potential field data by flying a set of paths which are not constrained to be parallel or define a rectangular grid pattern is described. The set of paths has one or more of the following features: two paths cross at heights differing by at least 50 metres; in a region of said survey paths in the same general direction are non-parallel by greater than 5 degrees; said paths include curved paths; said paths of said set of paths, taken together, do not substantially lie in a surface; said paths of said set of paths, taken together, define a surface wherein at least one of said paths defines one of two orthogonal directions in said surface such that said surface has a rate of change of height with distance in the other orthogonal direction of greater than 5 percent.

### SUMMARY

According to a first aspect of the invention, there is provided a method of conducting a potential field survey of a survey surface, the method comprising determining a set of paths along an observation surface at an observation height above the surface survey and measuring potential field data at points on said paths, wherein said set of paths comprises at least one reference path and a plurality of survey paths associated with said at least one reference path wherein the distance between each of the plurality of survey paths and the reference path is a function of the observation height.

The observation height may be determined using known topographical information on the area to be surveyed. Alternatively, the observation height may be determined by conducting an additional preliminary survey. The observation surface may be planar, e.g., the water surface in marine surveys, or may be non-planar, e.g. flying at different heights for airborne surveys.

The distance between each of the plurality of survey paths and the reference path may be proportional to the observation height. The distance between each survey path D_{N} in the plurality of survey paths and the reference path may be defined by

D_{N}=N×H×F

where
N is an index number of the survey path
H is the observation height and
F is a measurement factor.

F is a factor governed by decay characteristics of the potential field under investigation.

Said set of paths may define a generally fan-shaped pattern diverging from a common region. A fan survey ensures an optimal survey design; aiming to balance the requirement that the resultant geophysical data is not aliased but yet is acquired with the minimum amount of over sampling in the survey area. Minimising over sampling reduces the considerable costs associated with such surveys.

Said set of paths may comprise a plurality of reference paths with each reference path having a plurality of associated survey paths so as to define a sub-pattern in the set of paths. Each sub-pattern may have a generally similar shape or may have different shapes. The plurality of reference paths for each sub-pattern may be parallel (e.g. for simple topographies) or convergent or divergent (for more complex topographies). The parameters of the plurality of sub-patterns (e.g. relative arrangement of reference lines, shapes of sub-patterns, distance of each survey line from its associated reference line) are selected to control the number of intersections in the set of paths.

The number of intersections is important because the intersections allow the data to be “levelled” before processing. Levelling here is a generic term which covers techniques, which include one or more of the following: noise reduction, removal of low frequency drift, matching low frequency content of neighbouring lines, referencing data to a fixed height plane and the like. Thus the goal may be to force a maximum (practicable) number of crossovers over the total survey area (given a constraint, say, on total path length/survey time). The survey lines may not be parallel to any other survey line. The survey lines may not be straight. In general many of the survey lines may not traverse the whole survey from one side to the other.

Said set of paths may comprise at least one additional line to increase the number of intersections in said set of paths. This is particularly useful where there is only one sub-pattern or if there are insufficient intersections in some parts of the area to be surveyed. The at least one additional line may be generally orthogonal to the or each reference line. Alternatively, the at least one additional line may be arranged to pass through regions having no or few intersections (e.g. at the corners or edges of the overall pattern provided by the set of paths). Said set of paths may comprise a plurality of additional lines with the spacing between additional lines increasing in regions having increasing numbers of intersections.

The survey surface may have a complex shape and thus a trend surface may be overlaid on the survey surface to simplify its shape. The observation height may be measured orthogonal to the trend surface. For relatively simply topography, e.g. generally increasing or decreasing depths, the trend surface may be a generally straight inclined line whereby each survey line is a generally straight line. Alternatively, the survey surface may be undulating or otherwise complex and thus the trend surface may be a complex line whereby each survey line has a matching complex shape.

The aircraft or vessel conducting the survey may be equipped with a range of geophysical measurement equipment including one or more potential field measurement instruments, for example vector gravimeter, gravity gradiometer, magnetometer, magnetic gradiometer or other instruments.

An accurate DEM (digital elevation model) may be produced to provide the observation height using a combination of LIDAR (Laser radar) and an IMU (Inertial Measurement Unit) in conjunction with DGPS (Differential Global Positioning System) to correct the LIDAR data for the plane or vessel motion. The DEM and DGPS data may also be used to correct the measured potential field data for the terrain. Likewise aircraft acceleration, attitude, angular rate and angular acceleration data or vessel motion data may also be used to correct the output data of the potential field instrumentation. An onboard or remote sensor can be used to provide the position and motion information for the aircraft or vessel and/or the potential field instrumentation.

The plane or vessel may be fitted with any of a range of additional standard airborne geophysical survey instrumentation such as instrumentation for: GPS, DGPS, altimeter, altitude measurement, pressure measurement, hyperspectral scanner, an electromagnetic measurement (EM), a Time Domain Electromagnetic system (TDEM), a vector magnetometer, accelerometer, gravimeter, and other devices including other potential field measurement devices.

The outputs from instrumentation may be corrected using instrumentation in a fixed or movable base station, for example according to best practice at the time. Such equipment may include GPS and magnetic instrumentation and high quality land gravimeters. Data collected according to any of the above methods may be combined with any ground based or satellite based survey data to help improve the analysis, such data including terrain, spectral, magnetic or other data.

The invention further provides processor control code to implement the above-described methods, in particular on a computer-readable medium or a data carrier such as a disk, CD- or DVD-ROM, programmed memory such as read-only memory (Firmware), or on a data carrier such as an optical or electrical signal carrier. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

The invention also provides a computer readable medium or a data carrier carrying aircraft navigational data for a set of airborne potential field flight survey paths. The invention also provides a data carrier carrying vessel navigational data for a set of marine potential field flight survey paths.

Thus according to another aspect of the invention, there is provided a non-transitory computer-readable storage medium having stored therein instructions that when executed by a processor cause a computer system to receive survey data defining a set of paths along which a potential field measuring instrument is to be moved to conduct said potential field survey, and to store the survey data. The said paths define a generally fan-shaped pattern diverging from a common region. A separation between said paths is dependent upon a height above a surface over which the survey is to be performed and wherein said separation increases with increasing said height.

Said survey may comprise a marine gravity gradiometry survey. A said separation between two paths may be determined according to

D_{N}=N×H×F

where
N is an index number of the survey path
H is the observation height and.
F is a measurement factor governed by decay characteristic of the potential field to be survey.

According to another aspect of the invention there is provided a method of defining a potential field survey of a survey surface, the method comprising defining a set of paths along an observation surface at an observation height above the surface survey and measuring potential field data at points on said paths, wherein said set of paths comprises

at least one reference path and

a plurality of survey paths associated with said at least one reference path wherein the distance between each of the plurality of survey paths and the reference path is a function of the observation height.

According to another aspect of the invention, there is provided a computer-implemented system for conducting a potential field survey of a survey surface. The computer-implemented system comprising an inertial platform unit. The inertial platform configured to receive a set of paths along an observation surface at an observation height above the surface survey. The inertial platform further configured to measure potential field data at points on said paths, wherein said set of paths comprises at least one reference path, and a plurality of survey paths associated with said at least one reference path wherein the distance between each of the plurality of survey paths and the reference path is a function of the observation height. The inertial platform further configured to transmit the field data to a data collection system.

Other features of the previously described method of conducting a survey may also be applied to these data carrier aspects and method of the invention.

### BRIEF DESCRIPTION OF THE DRAWINGS

Various embodiments taught herein are illustrated by way of example, and not by way of limitation, in the figures of the accompanying drawings, in which:

FIG. 1 is an image of a complex underwater feature around a shelf;

FIG. 2 is a sketch showing a submarine canyon fan system;

FIG. 3a is a schematic drawing of a survey line being conducted over a topography;

FIG. 3b is a schematic drawing of a partial survey pattern based on FIG. 3a;

FIG. 3c is a flowchart of the creation and use of a survey pattern;

FIG. 4 is a schematic drawing of a simple survey pattern created from the partial survey pattern of FIG. 3b;

FIG. 5 is a schematic drawing of a compound survey pattern incorporating a plurality of the simple survey patterns of FIG. 4;

FIG. 6 is a schematic drawing of a complex compound survey pattern; and

FIG. 7 is a schematic drawing of a vessel for conducting a survey.

It will be recognized that some or all of the figures are schematic representations for purposes of illustration. The figures are provided for the purpose of illustrating one or more embodiments of the invention with the explicit understanding that they will not be used to limit the scope or the meaning of the claims.

### DETAILED DESCRIPTION OF THE DRAWINGS

Before turning to the figures which illustrate the exemplary embodiments in detail, it should be understood that the disclosure is not limited to the details or methodology set forth in the description or illustrated in the figures. It should also be understood that the terminology is for the purpose of description only and should not be regarded as limiting.

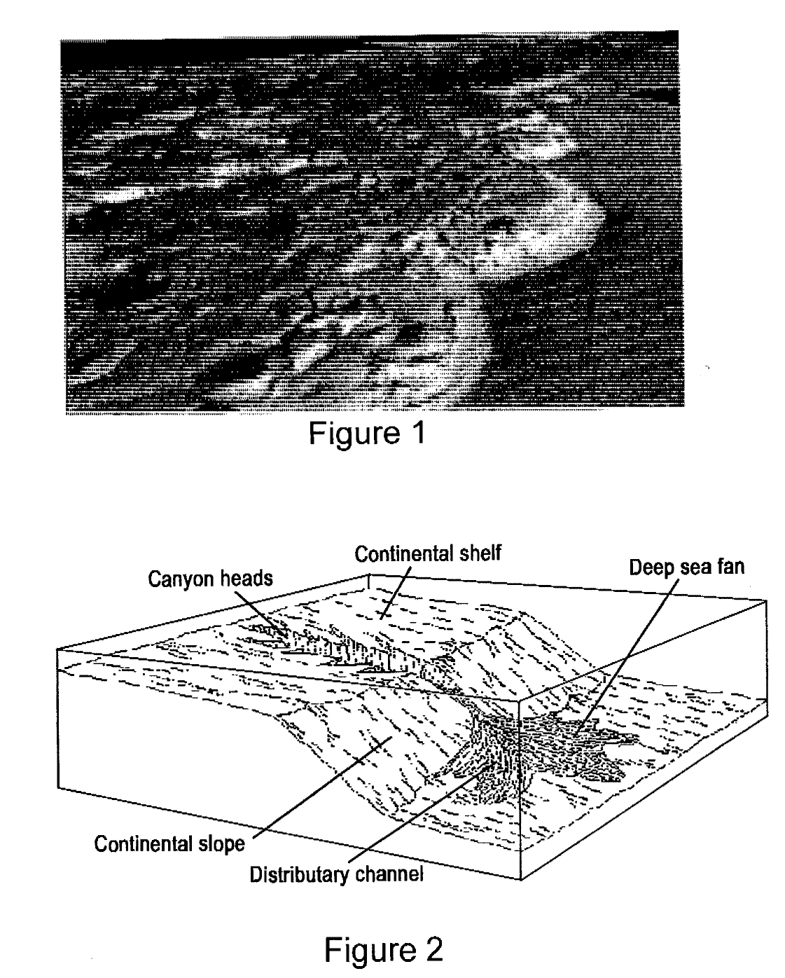

As shown in FIGS. 1 and 2, underwater topography may be complex. For example, in FIG. 1 there are deeper pockets on the generally shallower portion of the shelf. FIG. 2 illustrates a deep sea fan in which a canyon runs through the shallow continental shelf. According to the sampling theorem, any signal can be accurately reconstructed from values sampled at uniform intervals as long as it is sampled at a rate at least twice the highest frequency present in the signal. Failure to satisfy this requirement will result in aliasing of high-frequency components meaning that these components will appear to have frequencies lower that their true values.

In the light of sampling theorem, a survey over shallow waters must have significantly greater numbers of survey lines than a survey over deep waters. Consequently, in the case of rapidly changing bathymetry, a survey designed for shallow areas would oversample the signal in the deeper regions of the survey area (e.g. in the canyon of FIG. 2. or the deeper pockets of FIG. 1). Such a survey is non-optimal and will be costlier since the vessel must be at sea for longer to complete all the necessary survey lines.

A similar condition may be found where airborne surveys are flown in a pattern where altitude is dictated by non-geophysical conditions—safety and aircraft performance for instance.

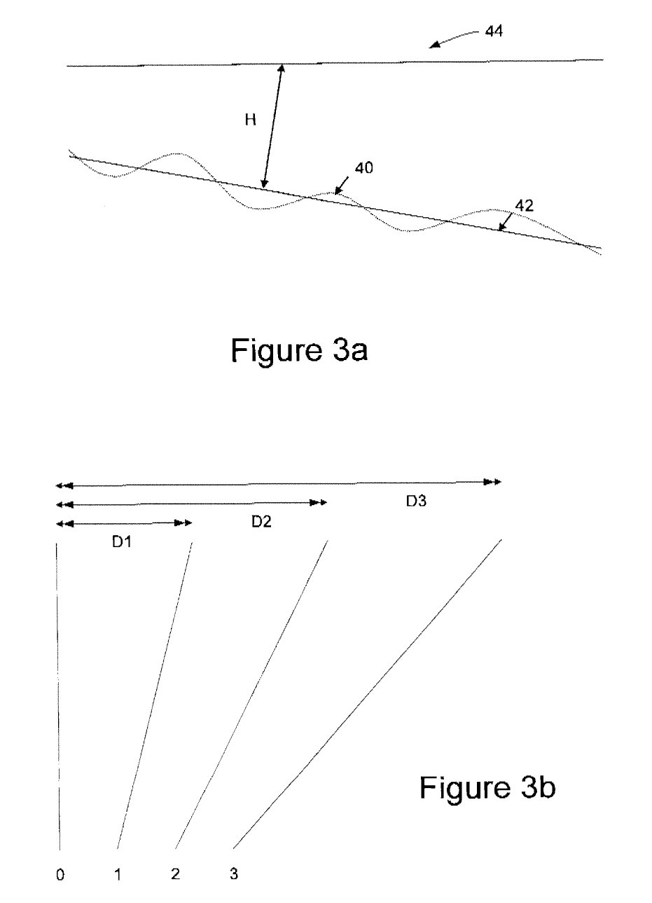

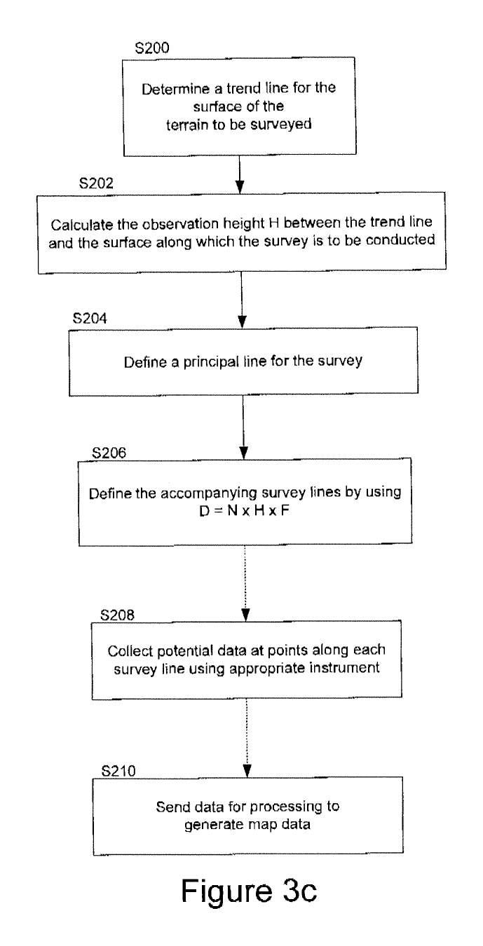

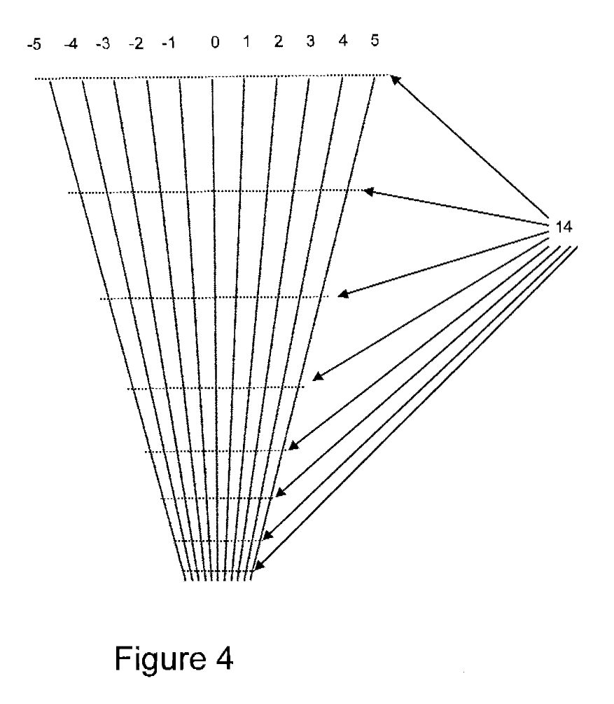

As shown in FIGS. 3a to 3c, to overcome the problems associated with aliasing of the signal and oversampling, it is preferable to design a survey of variable line spacing commensurate with the observation height and the topographical complexity of the interface under consideration. The marine and airborne surveys may be generalised by considering an observation surface 44 shown in FIG. 3a above a survey surface 42. The method is shown in FIG. 3c. At step S200, the survey surface is approximated to a trend line 42 which is an inclined plane sloping down from left to right. In the marine case, the observation surface is mean sea level and the survey surface is the bathymetric surface. In the airborne case, the observation surface is the surface governing the flight trajectory above the survey surface which is the topography. At step S202, the observation height, H, is used to describe the distance between the observation surface and the survey surface, with H being measured normal to survey surface. In the case of rapidly changing observation height a survey designed for the shallow areas would oversample the signal in the deeper regions of the survey area and is not an optimum survey design.

It is noted that in both cases the significant topography is considered to be the closest interface between materials of contrasting source parameter (density in the case of gravity and gravity gradiometry, magnetic susceptibility for magnetic field, conductivity for electrical and electromagnetic surveys). In the general case this may not necessarily be the topographic or bathymetric surface.

At step S204, a survey may be designed by defining at least one principal line, i.e. line 0 in FIG. 3b. The principal line may be central line of the area to be surveyed. At step S206, the accompanying survey lines are defined by determining the distance from the principal line of the accompanying survey lines from the following relationship:

D_{N}=N×H×F

### Where

N is the survey line index, a signed integer (1, 2, 3 . . . ) indicating the number of lines away from the principal with sign for direction
H is the observation height, described above.
F is a measurement factor specific to the survey in question (normally between 0.5 and 2).

The parameter F is specific to the survey. The measurement type, instrument noise characteristic, complexity of the detected surface relative to its trend surface and the precision required of the survey influence the choice of value assigned to F. Fundamentally F is governed by the decay rate of the signal being measured, for example gravity decays as 1/r², gravity gradient 1/r³ yielding values of F at ˜1.5 and ˜0.8 respectively. These values are modified by second order considerations mentioned above.

The survey conditions used to design an optimum survey as a function of observation height are thus driven by a minimum line spacing condition of F×H, where F is a factor governed by decay characteristic of the potential field under investigation. F may be varied to accommodate geophysical irregularities (extremes of topography in the detected surface) or economic requirements. The resultant survey design is a fan shape (for example as illustrated in FIG. 4), with multiple elements allowing control of the line spacing and survey shape. At step S208, the survey is conducted by following the principal and accompanying lines of the survey and measuring potential field data at points along these lines. At step S210, the collected data may then be processed to generate a terrain model. The processing may be done using any known techniques for example, WO2007/012895, GB2435523, GB2446174 and other published applications for the present applicant, which are herein incorporated by reference.

The survey shown in FIG. 4 has ten survey lines with five each side of the reference line 0. The lines to the left of the reference line are labelled with negative integers and those to the right of the reference line with positive integers. The overall pattern is fan-shaped with the survey lines diverging as observation height increases.

As illustrated, none of the survey lines of FIG. 4 intersect. However, the distribution of intersections between lines is important because they allow attenuation of survey noise induced by very long wavelength distortion between line measurements. If a measuring system exhibits long period distortion over time, having multiple measurements over the same spot enable the calculation of a correction for this error. Many such repeat occupations of the same space give statistical resilience to the calculation of the error model. The number of intersections required is a function of the noise signature of the instrument and measurement in question. The corrections made are normally long wavelength in form, so line intersections are required at relatively sparse intervals along the primary survey lines.

In FIG. 4, the presence of intersections is controlled by adding tie lines 14 which intersect with the survey lines. The tie lines 14 are generally parallel to each other and orthogonal to the primary survey direction (i.e. orthogonal to the reference line 0). The spacing of the tie lines 14 follows that of the survey lines, i.e. where the survey lines are more closely spaced together, the tie lines are also more closely spaced together. In other words, the distance between tie lines increases with the fan-shaped pattern. The tie lines may be termed secondary lines. Whilst they are shown as normally orthogonal to the primary survey direction to maximise survey efficiency, they may take any direction including a fan type configuration themselves.

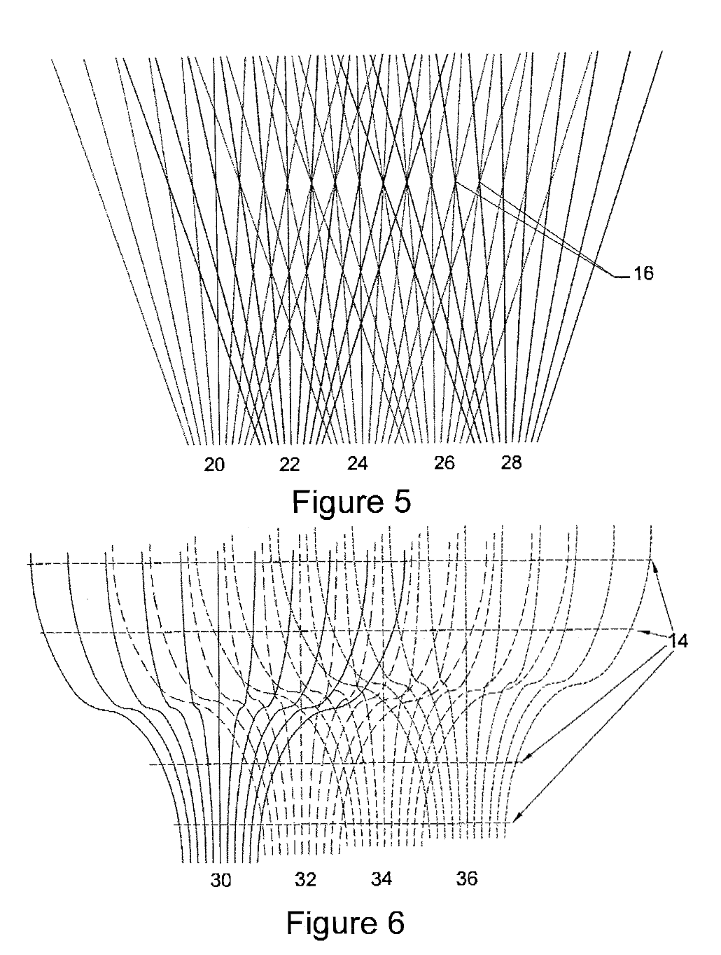

FIG. 5 shows a compound survey pattern comprising five fan-shaped sub-patterns 20, 22, 24, 26, 28. Each sub-pattern is similar to that of FIG. 4 but it will be appreciated that different sub-patterns may be used to compose the overall survey pattern. Each sub-pattern has a reference line and the reference lines may be parallel (for simple topography) or take a convergent or divergent arrangement in more complex situations.

In FIG. 5 there are no tie lines. In this case, the distribution of intersections 16 is controlled by the number of lines in each fan subset and by the number of overlapping patterns. Particularly for gravity gradiometry, it may be helpful to design the survey pattern so that the maximum number of intersections is on the steepest slope because steep bathymetry gradients give strong gravity gradiometry signals. However, this is not essential.

FIG. 6 shows a more complex compound pattern which is formed in a similar manner to that described above. In FIG. 6, the survey surface has a complex shape and thus a more complex trend line. Accordingly, the observation height H does not uniformly increase and the straight lines of each sub-pattern 30, 32, 34, 36 of the survey pattern are replaced with curved lines. Although there are intersections between lines of the sub-patterns, tie lines 14 are also used to increase the number of intersections (tie lines may be similarly used in FIG. 5). The spacing of the tie lines 14 is non-uniform so that the tie lines form two pairs. A first pair of tie lines 14 provides additional intersections in the region where the sub-pattern survey lines are tightly spaced and there are few intersections. A second pair of tie lines 14 provides additional intersections in the opposite end of the survey where there are also few intersections. The tie lines shown pass across the entire width of the survey but it will be appreciated that the tie lines may also be included across part of the survey, e.g. at the edges to provide additional intersections.

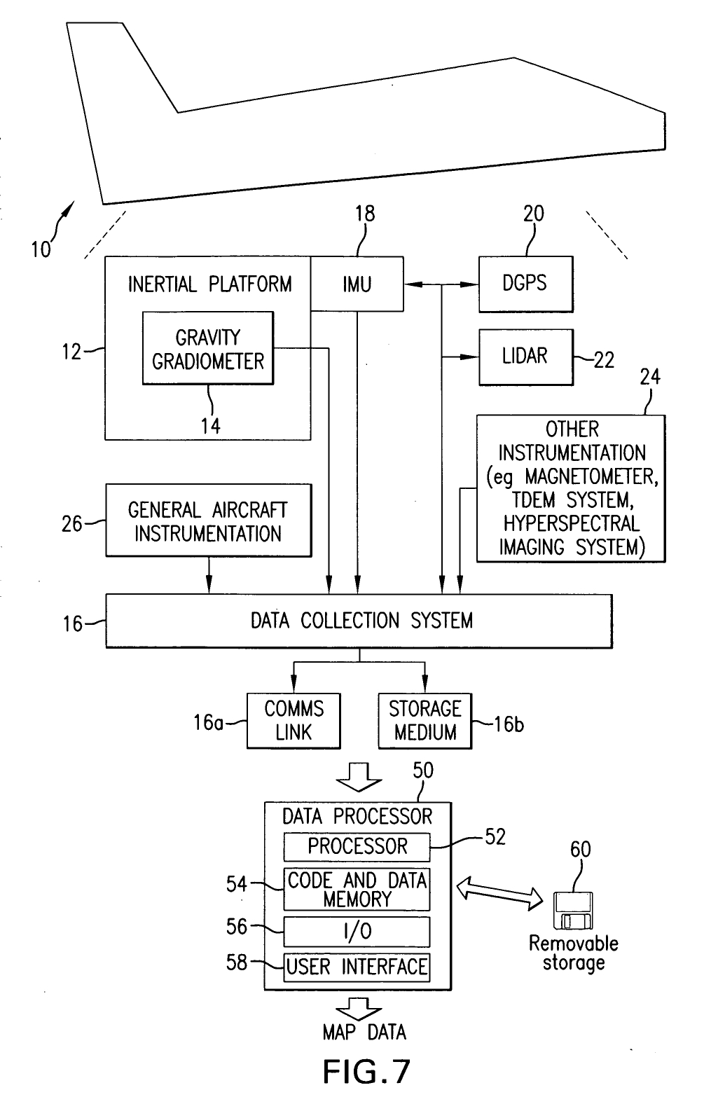

Referring now to FIG. 7, this shows an example of an aircraft 10 for conducting a potential field survey to obtain data for processing in accordance with a method as described above. As set out above, the survey may also be a marine survey in which case the aircraft may be replaced by a boat. The aircraft 10 or other vessel for conducting the survey comprises an inertial platform 12 on which is mounted a gravity gradiometer 14 (and/or vector magnetometer) which provides potential field survey data to a data collection system 16. The inertial platform 12 is fitted with an inertial measurement unit (IMU) 18 which also provides data to data collection system 16 typically comprising attitude data (for example, pitch, roll and yaw data), angular rate and angular acceleration data, and aircraft acceleration data. The aircraft is also equipped with a differential GPS system 20 and a LIDAR system 22 or similar to provide data on the height of the aircraft above the underlying terrain. Position and time data are preferably obtained from (D)GPS, optionally in combination with the IMU for accuracy.

The aircraft 10 may also be equipped with other instrumentation 24 such as a magnetometer, a TDEM (Time Domain Electromagnetic System) system and/or a hyperspectral imaging system, again feeding into the data collection system. The data collection system 16 also has an input from general aircraft instrumentation 26 which may comprise, for example, an altimeter, air and/or ground speed data and the like. The data collection system 16 may provide some initial data pre-processing, for example to correct the LIDAR data for aircraft motion and/or to combine data from the IMU 18 and DGPS 20. The data collection system 16 may be provided with a communications link 16a and/or non-volatile storage 16b to enable the collected potential field and position data to be stored for later processing. A network interface (not shown) may also be provided.

Data processing to generate map data for the potential field survey is generally (but not necessarily) carried out offline, sometimes in a different country to that where the survey data was collected. As illustrated a data processing system 50 comprises a processor 52 coupled to code and data memory 54, an input/output system 56 (for example comprising interfaces for a network and/or storage media and/or other communications), and to a user interface 58 for example comprising a keyboard and/or mouse. The code and/or data stored in memory 54 may be provided on a removable storage medium 60. In operation the data includes data collected from the potential field survey and the code comprises code to process this data to generate map data.

Potential field data includes, but is not limited to, gravimeter data, gravity gradiometer data, vector magnetometer data and true magnetic gradiometer data. Such data is characterised mathematically by a series of relationships which govern how the quantities vary as a function of space and how different types of measurement are related. The choice of instrumentation comes down simply to which instrument measures the desired quantity with the largest signal to noise. Elements and representations of a potential field may be derived from a scalar quantity.

For gravity, the relevant potential is the gravity scalar potential, Φ(r), defined as

$$Φ ( r ) = \int \int \int \frac{G ρ ( {r}^{′} )}{\vert r - {r}^{′} \vert} {d}^{3} {r}^{′}$$

Where r, ρ(r′), G are respectively, the position of measurement of the gravity field, the mass density at location r′, and the gravitational constant. The gravitational force, which is how the gravitational field is experienced, is the spatial derivative of the scalar potential. Gravity is a vector in that it has directionality as is well known—gravity acts downwards. It is represented by three components with respect to any chosen Cartesian coordinate system as:

$$g = ( {g}_{x} , {g}_{y} , {g}_{z} ) = ( \frac{\partial Φ ( r )}{\partial x} , \frac{\partial Φ ( r )}{\partial y} , \frac{\partial Φ ( r )}{\partial z} )$$

Each of these three components varies in each of the three directions and the nine quantities so generated form the Gravity gradient tensor:

$$G = ( \begin{matrix}{G}_{xx} & {G}_{xy} & {G}_{xz} \\ {G}_{yx} & {G}_{yy} & {G}_{yz} \\ {G}_{zx} & {G}_{zy} & {G}_{zz}\end{matrix} ) = ( \begin{matrix}\frac{\partial }{\partial x} \frac{\partial Φ ( r )}{\partial x} & \frac{\partial }{\partial x} \frac{\partial Φ ( r )}{\partial y} & \frac{\partial }{\partial x} \frac{\partial Φ ( r )}{\partial z} \\ \frac{\partial }{\partial y} \frac{\partial Φ ( r )}{\partial x} & \frac{\partial }{\partial y} \frac{\partial Φ ( r )}{\partial y} & \frac{\partial }{\partial y} \frac{\partial Φ ( r )}{\partial zx} \\ \frac{\partial }{\partial z} \frac{\partial Φ ( r )}{\partial x} & \frac{\partial }{\partial z} \frac{\partial Φ ( r )}{\partial y} & \frac{\partial }{\partial z} \frac{\partial Φ ( r )}{\partial z}\end{matrix} )$$

The mathematical theory of potential fields is well established—the fundamental equations and relationships follow from analysis of the properties of the scalar potential function, its derivatives, its Fourier transforms and other mathematical quantities.

No doubt many other effective alternatives will occur to the skilled person. It will be understood that the invention is not limited to the described embodiments and encompasses modifications apparent to those skilled in the art lying within the spirit and scope of the claims appended hereto.

Moreover, various functions described herein can be implemented in hardware, software, firmware, or any combination thereof. If implemented in software, the functions can be stored on or transmitted over as one or more instructions or code on a computer-readable medium. Computer-readable media can be non-transitory in nature and can include both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any physical connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc (BD), where disks usually reproduce data magnetically and discs reproduce data optically with lasers. Combinations of the above should also be included within the scope of computer-readable media.

1. A method of conducting a potential field survey of a survey surface, the method comprising:
determining a set of paths along an observation surface at an observation height above the surface survey; and
measuring potential field data at points on said paths, wherein said set of paths comprises
at least one reference path, and
a plurality of survey paths associated with said at least one reference path wherein the distance between each of the plurality of survey paths and the reference path is a function of the observation height.

2. The method according to claim 1, wherein the distance between each survey path D_{N} in the plurality of survey paths and the reference path is defined by
D_{N}=N×H×F, wherein N is an index number of the survey path,
H is the observation height, and
F is a measurement factor.

3. The method according to claim 1, wherein said set of paths defines a fan-shaped pattern diverging from a common region.

4. The method according to claim 1, wherein said set of paths comprises a plurality of reference paths with each reference path having a plurality of associated survey paths so as to define a sub-pattern in the set of paths.

5. The method according to claim 4, wherein each sub-pattern has a generally similar shape.

6. The method according to claim 4, wherein the plurality of reference paths are parallel.

7. The method according to claim 4, wherein the parameters of the plurality of sub-patterns are selected to control the number of intersections in the set of paths.

8. The method according to claim 1, wherein said set of paths comprises at least one additional line to increase the number of intersections in said set of paths.

9. The method according to claim 8, wherein the at least one additional line is generally orthogonal to the or each reference line.

10. The method according to claim 8, wherein said set of paths comprises a plurality of additional lines with the spacing between additional lines increasing in regions having increasing numbers of intersections.

11. The method according to claim 1, wherein a trend surface is overlaid on the survey surface and the observation height is measured normal to the trend surface.

12. The method according to claim 11, wherein the trend surface is a generally straight inclined line whereby each survey line is a generally straight line.

13. The method according to claim 11, wherein the trend surface is a complex line whereby each survey line has a matching complex shape.

14. The method according to claim 1, comprising measuring gravity gradiometry data.

15. A non-transitory computer-readable storage medium having stored therein instructions that when executed by a processor cause a computer system to:
receive survey data defining a set of paths along which a potential field measuring instrument is to be moved to conduct said potential field survey; and
store the survey data, wherein said paths define a generally fan-shaped pattern diverging from a common region, and wherein a separation between said paths is dependent upon a height above a surface over which the survey is to be performed and wherein said separation increases with increasing said height.

16. The non-transitory computer-readable storage medium of claim 15, wherein said survey comprises a marine gravity gradiometry survey.

17. The non-transitory computer-readable storage medium of claim 15, wherein said separation between two paths is determined according to
D_{N}=N×H×F, wherein N is an index number of the survey path,
H is an observation height, and
F is a measurement factor governed by decay characteristic of the potential field to be survey.

18. A method of defining a potential field survey of a survey surface, the method comprising:
defining a set of paths along an observation surface at an observation height above the surface survey; and
measuring potential field data at points on said paths, wherein said set of paths comprises
at least one reference path, and
a plurality of survey paths associated with said at least one reference path wherein the distance between each of the plurality of survey paths and the reference path is a function of the observation height.

19. A computer-implemented system for conducting a potential field survey of a survey surface, the computer-implemented system comprising:
an inertial platform configured to
receive a set of paths along an observation surface at an observation height above the surface survey,
measure potential field data at points on said paths, wherein said set of paths comprises at least one reference path, and a plurality of survey paths associated with said at least one reference path wherein the distance between each of the plurality of survey paths and the reference path is a function of the observation height, and
transmit the field data to a data collection system.
